(19) United States
(12) Patent Application Publication
(10) Pub. No.: US 2011/0000359 A1
(43) Pub. Date: Jan. 6, 2011

(54) MUSIC COMPOSITION DATA ANALYZING DEVICE, MUSICAL INSTRUMENT TYPE DETECTION DEVICE, MUSIC COMPOSITION DATA ANALYZING METHOD, MUSICAL INSTRUMENT TYPE DETECTION DEVICE, MUSIC COMPOSITION DATA ANALYZING PROGRAM, AND MUSICAL INSTRUMENT TYPE DETECTION PROGRAM

(75) Inventors: Minoru Yoshida, Saitama (JP); Hiroyuki Ishihara, Kanagawa (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/867,793

(22) PCT Filed: Feb. 15, 2008
(86) PCT No.: PCT/JP2008/052561

§ 371 Date: Aug. 20, 2010

(51) Int. Cl. G10H 1/00

(52) U.S. Cl. 84/601

(57) ABSTRACT

There is provided a musical instrument kind detection apparatus, etc., permitting improvement of detection rate of musical instrument based on the instrument sound in comparison with the conventional prior art. A musical composition analysis section AN1 analyzes musical composition data corresponding to a musical composition and generates a signal for detecting a kind of musical instrument. A musical feature along a temporal axis of the musical composition data Sin, e.g., a single musical instrument sound data Stonal is extracted. A musical instrument detection section D1 detects a kind of the musical instrument based on the detected musical feature.

### TECHNICAL FIELD

The present invention relates to a technical field of a musical composition data analysis apparatus and a musical instrument kind detection apparatus, a musical composition data analysis method and a musical instrument kind detection method, as well as a musical composition data analysis programand a musical instrument kind detection program. The present invention relates more specifically to the technical field of the musical composition data analysis apparatus, method and program for detecting the kinds, etc. of the musical instrument on which the musical composition is performed, and the musical instrument kind detection apparatus, method and program utilizing results of analysis.

### BACKGROUND OF THE INVENTION

A so-called home server or a portable audio equipment has recently been generally used to electronically record many musical composition data each corresponding to musical compositions and reproduce the same to enjoy music. When enjoying the music, a desired musical composition is preferably searched rapidly from many musical compositions.

There have been various search methods to conduct such a search. One of the search methods is a search method in which a search using a key word of “musical instrument” in such a manner as “musical composition including a piano performance” or “musical composition including a guitar performance”. Realization of such a search method requires a rapid and appropriate detection to be made on what musical instrument the musical composition is performed.

So, there have recently been developed search methods as described for example in Patent Documents No. 1 to No. 3 as indicated below. In the conventional search methods disclosed in these Patent Documents No. 1 to No. 3, all the musical composition data as inputted externally are subjected to the same musical instrument recognition processing, and the all the musical compositions are subjected to the same musical instrument recognition processing:

### Patent Document No. 1: Japanese Patent Provisional Publication No. 2005-49859;

Patent Document No. 2: Domestic Republication No. 2006-508390 of the POT international application; and

### Patent Document No. 3: Japanese Patent Provisional Publication No. 2003-15684

### DISCLOSURE OF THE INVENTION

### Subject to be Solved by the Invention

However, in the conventional prior art described in each of the above-indicated patent documents, all the musical compositions or the whole single musical composition are subjected to the same musical instrument recognition processing, thus may be leading to a lower rate of musical instrument recognition. This is because the whole single musical composition being subjected to the musical instrument recognition processing causes parts of the composition, which are not appropriately used for recognition of the musical instrument, to be subjected to the recognition processing, with the result the general rate of the music instrument recognition is decreased.

An example of a subject to be solved by the invention, which has been made in view of the above-described problems, is to provide a musical instrument kind detection apparatus, etc., which permits to improve the rate of detection of the musical instrument based on the sound of the musical instrument on which the musical composition is performed, in comparison with the conventional prior art.

### Means to Solve the Subject

In order to solve the above-mentioned problems, the musical composition data analysis apparatus of the present invention claimed in claim 1, which analyzes musical composition data corresponding to a musical composition and generates a kind detection signal for detecting a kind of musical instrument on which the musical composition is performed, comprises: a detection unit that detects a musical feature along a temporal axis of the musical composition data; and a generation unit that generates the kind detection signal based on the musical feature as detected.

In order to solve the above-mentioned problems, the musical instrument kind detection apparatus of the present invention claimed in claim 5 comprises: the musical composition data analysis apparatus as claimed in any one of claims 1 to 4; and a kind detection unit that utilizes the musical composition data corresponding to the musical feature indicated by the kind detection signal as generated to detect said kind.

In order to solve the above-mentioned problems, the musical instrument kind detection apparatus of the present invention claimed in claim 6, which detects a kind of musical instrument on which a musical composition is performed, comprises: a first detection unit that detects the kind of musical instrument on which the musical composition is performed, based on musical composition data corresponding to the musical composition, to generate a kind signal; a second detection unit that detects a single musical sound section in a temporal section of the musical composition data, which is judged acoustically as being composed of any one of a sound of a single musical instrument and a singing sound of a single singer; and a kind judgment unit that judges, as the kind of musical instrument to be detected, the kind, which is indicated by the kind signal generated based only on the musical composition data included in the single musical sound section as detected, of the kind signals as generated.

In order to solve the above-mentioned problems, the musical composition data analysis method of the present invention claimed in claim 9, which analyzes musical composition data corresponding to a musical composition and generates a kind detection signal for detecting a kind of musical instrument on which the musical composition is performed, comprises: a detection step for detecting a musical feature along a temporal axis of the musical composition data; and a generation step for generating the kind detection signal based on the musical feature as detected.

In order to solve the above-mentioned problems, the musical instrument kind detection method of the present invention claimed in claim 10, which detects a kind of musical instrument on which a musical composition is performed, comprises: a first detection step for detecting the kind of musical instrument on which the musical composition is performed, based on musical composition data corresponding to the musical composition, to generate a kind signal; a second detection step for detecting a single musical sound section in a temporal section of the musical composition data, which is judged acoustically as being composed of any one of a sound of a single musical instrument and a singing sound of a single singer; and a kind judgment step for judging, as the kind of musical instrument to be detected, the kind, which is indicated by the kind signal generated based only on the musical composition data included in the single musical sound section as detected, of the kind signals as generated.

In order to solve the above-mentioned problems, the musical composition data analysis program of the present invention claimed in claim 11, which is to be executed by a computer to which musical composition data corresponding to a musical composition are inputted, to cause the computer to function as the musical composition data analysis apparatus as claimed in any one of claims 1 to 4.

In order to solve the above-mentioned problems, the musical instrument kind detection program of the present invention claimed in claim 12, which is to be executed by a computer to which musical composition data corresponding to a musical composition are inputted, to cause the computer to function as the musical composition kind detection apparatus as claimed in any one of claims 5 to 8.

### BRIEF DESCRIPTION OF THE DRAWINGS

FIG. 1 is a block diagram showing a schematic structure of a musical composition reproduction apparatus according to the first embodiment of the present invention;

FIG. 2 is a view illustrating contents of a detection result table according to the first embodiment of the present invention;

FIG. 3 is a block diagram showing a schematic structure of a musical composition reproduction apparatus according to the second embodiment of the present invention;

FIG. 4 is a view illustrating contents of a detection result table according to the second embodiment of the present invention;

FIG. 5 is a block diagram showing a schematic structure of a musical composition reproduction apparatus according to the third embodiment of the present invention;

FIG. 6 is a view illustrating contents of a detection result table according to the third embodiment of the present invention;

FIG. 7 is a block diagram showing a schematic structure of a musical composition reproduction apparatus according to the fourth embodiment of the present invention; and

FIG. 8 is a view illustrating contents of a detection result table according to the fourth embodiment of the present invention.

### DESCRIPTION OF REFERENCE NUMERALS

1 data input section
2 single musical instrument sound section detection section
3 sound producing position detection section
4 feature amount calculation section
5 comparison section
6 condition input section
7 results storage section
8 reproduction section
10 sound producing period detection section
11 model switching section
12 musical composition structure analysis section
13, 14 switch
AN1, AN2, AN3, AN4 musical composition analysis section
D1, D2 musical instrument detection section
S1, S2, S3, S4 musical component reproduction apparatus
DB1, DB2 model accumulation section
T1, T2, T3, T4 detection results table

### BEST MODE FOR CARRYING OUT THE INVENTION

Now, the best mode for carrying out the present invention will be described below with reference to the drawings. In each of the embodiments, the present invention is applied to a musical composition reproduction apparatus that permits to search a musical composition which is performed on a desired musical instrument, from recording media such as a musical DVD (Digital Versatile Disc) or a musical server, in which many musical compositions have been recorded and reproduce the same.

### (I) First Embodiment

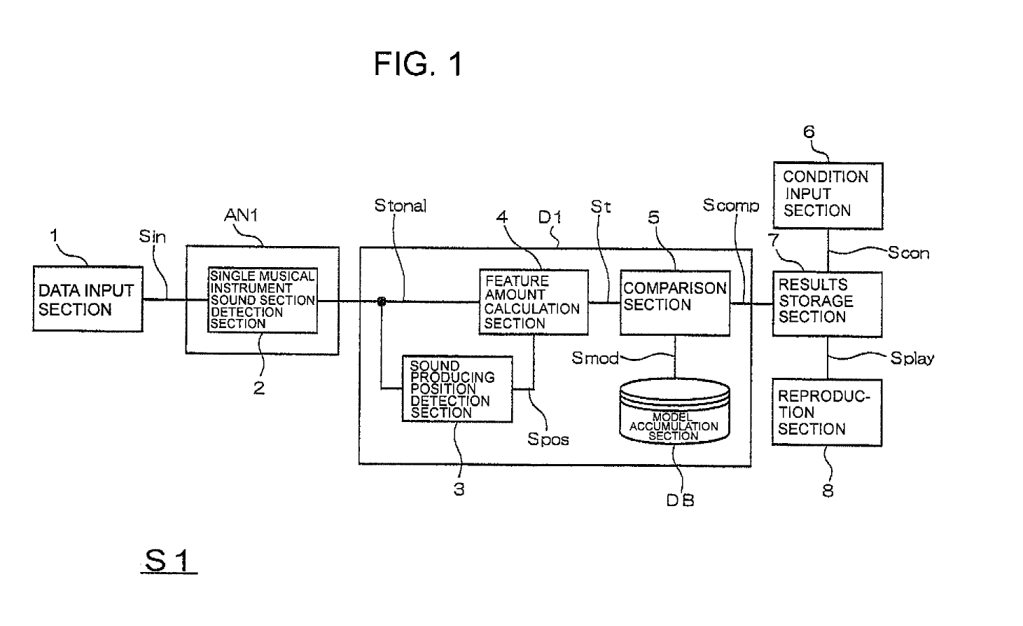

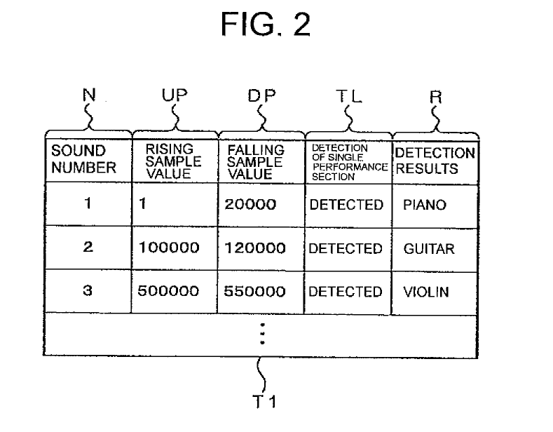

Now, the first embodiment of the present invention will be described with reference to FIGS. 1 and 2. FIG. 1 is a block diagram showing a schematic structure of a musical composition reproduction apparatus according to the first embodiment of the present invention and FIG. 2 is a view illustrating contents of a detection result table according to the first embodiment of the present invention.

As shown in FIG. 1, the musical composition reproduction apparatus S1 according to the first embodiment of the present invention includes a data input section 1, a musical composition analysis section AN1, a musical instrument detection section D1 serving as a kind detection unit, a condition input section 6 having operation buttons, and a keyboard or a mouse, etc, a result storage section 7 having a hard disc drive, etc, and a reproduction section 8 having a not showndisplayhaving a liguidcrystaldisplay and a not shown loudspeaker. The musical composition analysis section AN1 includes a single musical instrument sound section detection section 2 serving as the detection unit and the generation unit. In addition, the musical instrument detection section D1 includes a feature amount calculation section 4, a comparison section 5 and a model accumulation section DB1.

Now, operation will be described below.

First, the musical composition data corresponding to the musical composition, which is to be subjected to a musical instrument kind detection processing according to the first embodiment of the present invention is outputted from the above-described musical DVD and then outputted through the data input section 1 to the musical composition analysis section AN1 in the form of musical composition data Sin.

Thus, the single musical instrument sound section detection section 2 constituting the musical composition analysis section AN1 extracts, from the whole original musical composition data Sin, the musical composition data Sin, which falls under a single musical sound section in a temporal section of the musical composition data Sin, which may be judged acoustically as being composed of any one of a sound of a single musical instrument and a singing sound of a single singer. The extraction results are inputted to the musical instrument detection section D1 in the form of a single musical instrument sound data Stonal. The single musical instrument sound section may include, in addition to the temporal section in which only the musical instrument such as a piano or a guitar is played, a temporal section in which the guitar is played as a main instrument, while beating out a certain rhythm on a drum serving as a sub instrument.

Then, the musical instrument detection section D1 detects, based on the single musical instrument sound data Stonal as inputted from the musical composition analysis section AN1, a musical instrument on which the musical composition in the temporal section corresponding to the single musical instrument sound data Stonal is performed, and generates a detection result signal Scomp, which is indicative of the detection results, and then outputs the same to a results storage section 7.

The results storage section 7 stores in its nonvolatile element the detection results of the musical instrument as inputted as the detection result signal Scomp, together with information indicative of the name of the musical composition, the name of the performer and the like, corresponding to the original musical composition data Sin. The information indicative of the name of the musical composition, the name of the performer and the like may be acquired through a not shown network, or the like, in a corresponding relationship with the musical composition data Sin, which has been subjected to the musical instrument detection.

Then, the condition input section 6, which is operated by a user who wishes to reproduce the musical composition, generates a condition information Scon indicative of the search conditions and the like of the musical composition, which include the name of musical instrument as desired on which the musical composition is performed, and outputs the same to the results storage section 7.

Then, the results storage section 7 compares the musical instrument, which is indicated by the detection result signal Scamp for each of the musical composition data Sin as outputted from the musical instrument detection section D1, with the musical instrument, which is included in the above-mentioned condition information Scan. Thus, the results storage section 7 generates a reproduction information Splay, which includes the name of the musical composition, the name of the performer and the like, corresponding to the detection result signal Scamp including the musical instrument that consists with the musical instrument included in the condition information Scon, and outputs the same to the reproduction section 8.

Finally, the reproduction section 8 displays the contents of the reproduction information Splay in the not shown display. When the user selects the musical composition to be reproduced (i.e., the musical composition including its part, which is performed on the musical instrument as desired by the user), the reproduction section 8 acquires the musical composition data Sin corresponding to the musical composition as selected, through the not shown network, and then reproduces and outputs the same.

Now, description of operation of the above-described musical instrument detection section D1 will be given with reference to FIG. 1.

The above-described single musical instrument sound data Stonal as inputted to the musical instrument detection section D1 is outputted to each of the feature amount calculation section 4 and the sound producing position detection section 3 as shown in FIG. 1.

Then, the sound producing position detection section 3 detects, as the single musical instrument sound data Stonal in a manner as described later, a timing at which a sound that corresponds to the single musical note in the musical score, which corresponds to the single musical instrument sound data Stonal, is produced by the musical instrument, the performance on which has been detected, as well as a period of time during which the above-mentioned sound is produced. The detection results are outputted, as the sound producing signal Spos, to the feature amount calculation section 4.

The feature amount calculation section 4 calculates an amount of acoustic feature of the single musical instrument sound data Stonal for the respective sound producing positions indicated by the sound producing signal Spas, in accordance with the conventionally known feature amount calculation method, and then outputs, as the feature amount signal St, to the comparison section 5. The above-mentioned feature amount calculation method must be a method corresponding to the model comparison method in the comparison section 5. The feature amount calculation section 4 generates the feature amount signal St for each of the single sounds (i.e., the sound corresponding to the single musical note) in the single musical instrument sound data Stonal.

Then, the comparison section 5 compares the amount of acoustic feature of the respective single sound indicated by the feature amount signal St, with the acoustic model for the respective musical instruments, which are accumulated in the model accumulation section DB1 and outputted as the model signal Smod to the comparison section 5.

The data corresponding to the musical instrument sound model utilizing for example a HMM (Hidden Markov Model) is accumulated for the respective musical instruments in the model accumulation section DB1, and outputted to the comparison section 5 in the form of the model signal Smod for the respective musical instrument sound model.

The comparison section 5 conducts a recognition processing of the musical instrument sound utilizing for example a so-called Viterbi algorithm, for the respective single sound. More specifically, a logarithmic likelihood of the musical instrument sound model relative to the amount of feature of the respective single sound is calculated, the musical instrument sound model having the maximum logarithmic likelihood is used as the musical instrument sound model corresponding to the musical instrument on which the single sound is produced, and the above-mentioned detection result signal Scomp indicative of this musical instrument is outputted to the results storage section 7. There may be applied a configuration in which a threshold for the above-mentioned logarithmic likelihood is set to exclude the recognition results having the logarithmic likelihoods not exceeding the threshold, thus excluding the recognition results having the low reliability.

Now, a more specific description of operation of the above-described single musical instrument sound section detection section 2 will be given below.

The single musical instrument sound section detection section 2 according to the first embodiment of the present invention detects the above-described single musical instrument sound section, based on a principle of applying the so-called (single) sound producing mechanism model to the musical instrument sound producing mechanism model.

More specifically, in a string beat instrument and a string flip instrument such as a piano and a guitar, vibration of the string serving as a sound source generally results in attenuation of power of sound from just after the vibration, and then the sound trails off as resonance. As a result, in such a string beat instrument and a string flip instrument, a so-called linear predictive residual power becomes smaller. To the contrary, in case where the plurality of musical instruments are performed simultaneously, the musical instrument sound producing mechanism model to which the above-mentioned soundproducingmechanismmodel is applied, cannot be used, and the linear predictive residual power becomes larger.

The single musical instrument sound section detection section 2 makes a judgment based on an amount of the linear predictive residual power in the musical composition data, and judges the temporal section of the musical composition data Sin having the linear predictive residual power, which does not exceed a threshold as previously and experimentally set for the linear predictive residual power, as not being the single musical instrument sound section for the string beat instrument or the string flip instrument, and ignores the same. To the contrary, it judges the temporal section of the musical composition data Sin having the linear predictive residual power, which exceeds the threshold, as being the single musical instrument sound section. Thus, the single musical instrument sound section detection section 2 extracts the musical composition data Sin, which exists in the temporal section judged as the single musical instrument sound section, and outputs the same to the musical instrument detection section D1 in the form of the single musical instrument sound data Stonal.

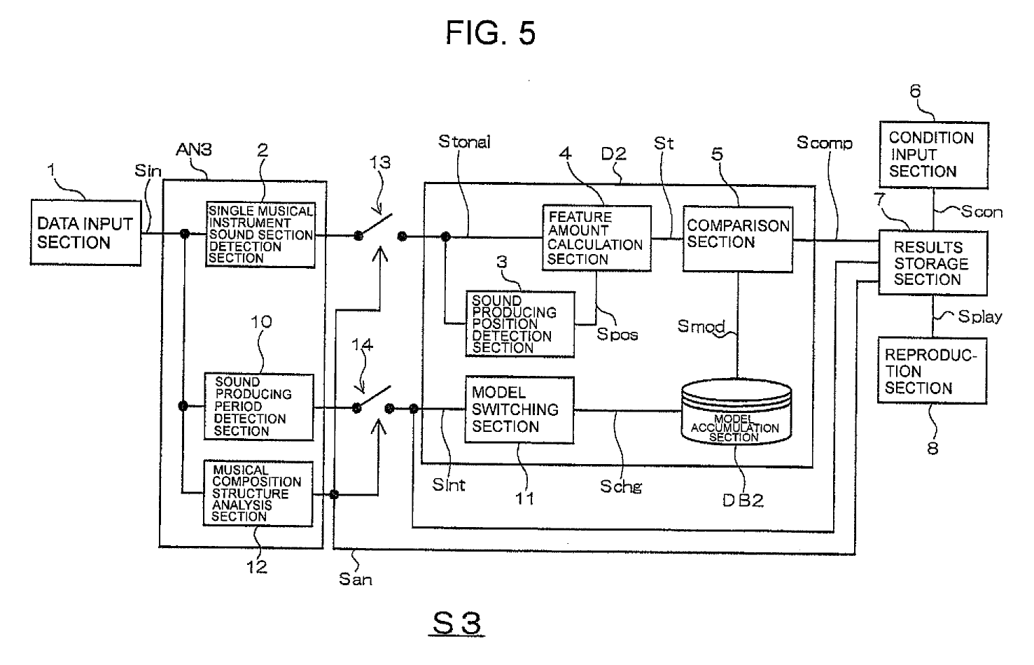

The above-described operation of the single musical instrument sound section detection section 2 is based on the contents of PCT/JP2007/55899 filed by the same applicant of the present invention, and more specifically on the technique described in paragraphs 0071 to 0081 of the specification of the above-indicated application and shown in FIG. 5 thereof.

Now, a more specific description of operation of the above-described soundproducingposition detection section 3 will be given below.

The sound producing position detection section 3 causes the musical composition data as inputted as the above-mentioned single musical instrument sound data Stonal to be subjected to a sound producing start timing detection processing and a sound producing finish timing detection processing to generate the above-mentioned sound producing signal Spos.

The specific applicable processing as the sound producing start timing detection processing may include for example a processing of detecting a sound producing start timing in view of temporal variation of time waveform, and a processing of detecting a sound producing start timing in view of variation of the amount of feature in a temporal-frequency space. Both of these processing may be applied together.

In the former case, a section having a large amount of inclination of a temporal axis waveform, variation in period of time of power, variation in phase time or rate of pitch time variation, as the single musical instrument sound data Stonal, is detected and the above-mentioned section is used as the sound producing start timing. In the latter case, in view of the fact that the power value in the whole frequency component increases with a sharp rising of the sound, a temporal variation of waveform for predetermined frequency bands is observed and detected, and the timing corresponding to it is used as the sound producing start timing, or a section having a high rate of temporal variation of a so-called barycentric frequency is detected, and the timing corresponding to it is used as the sound producing start timing.

The specific applicable processing as the sound producing finish timing detection processing may include for example the first processing of using, as the sound producing finish timing, a timing just before the sound producing start timing for the next sound in the single musical instrument sound data Stonal, the second processing of using, as the sound producing finish timing, a timing to provide a lapse of predetermined time after the above-mentioned sound producing start timing, and the third processing of using, as the sound producing finish timing, a timing to provide a lapse of time from the above-mentioned sound producing start timing to a time at which the acoustic power as the single musical instrument sound data Stonal decreased to the predetermined power bottom value. In the way to determine the predetermined time in the above-mentioned second processing, on the assumption that a value of average BPM (Beat Per Minute) is for example “120”, the following relationship is preferable: Predetermined time=120/60=2 (second) (in four, 2/4=0.5 second/beat).

Now, description will be given with reference to FIG. 2, of the contents stored in the results storage section 7, as the results of the musical instrument detection processing in the musical composition reproduction apparatus S1 according to the first embodiment of the present invention.

The contents of the above-mentioned detection result signal Scomp as obtained as the above-described operation of the musical composition analysis section AN1 according to the first embodiment of the present invention as well as the above-described operation of the musical instrument detection section D1, may include, for the respective single sounds as detected/specified by the sound producing position detection section 3 as shown in FIG. 2; a sound number information for making the single sound distinguishable from the other sound; a rising sample value information indicative of the sample value corresponding to the above-described sound producing start timing; a falling sample value information indicative of the sample value corresponding to the above-described sound producing finish timing; a single performance section detection information indicative of as to whether or not the above-described singlemusical instrument sound section detection section 2 has operated; and a detection result information including the name of the musical instrument as detected. The results storage section 7 stores the respective information as a detection result table T1 as exemplified in FIG. 2. The detection result table T1 includes a column “N” of the sound number, in which the above-mentioned sound number information is described; a column “UP” of the rising sample value, in which the rising sample value information is described; a column “DP” of the falling sample value, in which the falling sample value information is described; a column “TL” of the single performance section detection, in which the above-mentioned single performance section detection information is described; and a column “R” of the detection results, in which the above-mentioned detection result information is described.

When the condition information Soon having the contents of for example “Single performance section detection: To be detected; Musical instrument: piano” is inputted to the results storage section 7, in which the detection result table T1 has been stored, the search is conducted in the detection result table T1 on the basis of the inputted conditions, and the information that includes the name of the musical composition, the name of the performer and the like, corresponding to the musical composition data Sin including the single musical instrument sound data Stonal of the sound number “1” (see FIG. 2) is outputted as the above-mentioned reproduction information Splay to the reproduction section 8.

In the above-described operation of the musical component reproduction apparatus S1 according to the first embodiment of the present invention, the single musical instrument sound section is detected as the musical feature along the temporal axis of the musical composition data Sin, and the single musical instrument sound data Stonal included in the single musical instrument sound section as detected is used to detect the kind of the musical instrument. It is therefore possible to make the kind detection matching with the musical feature in the musical composition data Sin of the musical composition, which includes the performance on the musical instrument, the kind of which is be detected, with a high accuracy.

Therefore, it is possible to detect the kind of musical instrument with a high accuracy, in comparison with a detection in which the musical instrument is detected with the use of the whole musical composition data Sin.

In addition, use of the single musical instrument sound data Stonal may cause only the musical composition data Sin, which is composed of the single sound of the musical instrument, etc., to be subjected to the kind detection of the musical instrument, thus improving detection accuracy of the kind thereof.

The inventors of the present invention made specific experiments about high accuracy of the musical instrument detection processing according to the first embodiment of the present invention, and then obtained experimental results, that the detection rate (accuracy rate) of the music instrument detection processing utilizing the whole musical composition data Sin was 30% in the number of sound production of 48, and the detection rate of the music instrument detection processing utilizing the other sections (i.e., only the musical composition data Sin, which was performed by the plurality of musical instruments) than the single musical instrument sound data Stonal in the musical composition data Sin was 6% in the number of sound production of 31, while the detection rate in case where the single musical instrument sound data Stonal was utilized for detection of the kind of musical instrument was 76% in the number of sound production of 17. These results revealed that the operation of the musical component reproduction apparatus S1 according to the first embodiment of the present invention provided excellent technical effects in high detection rate.

### (II) Second Embodiment

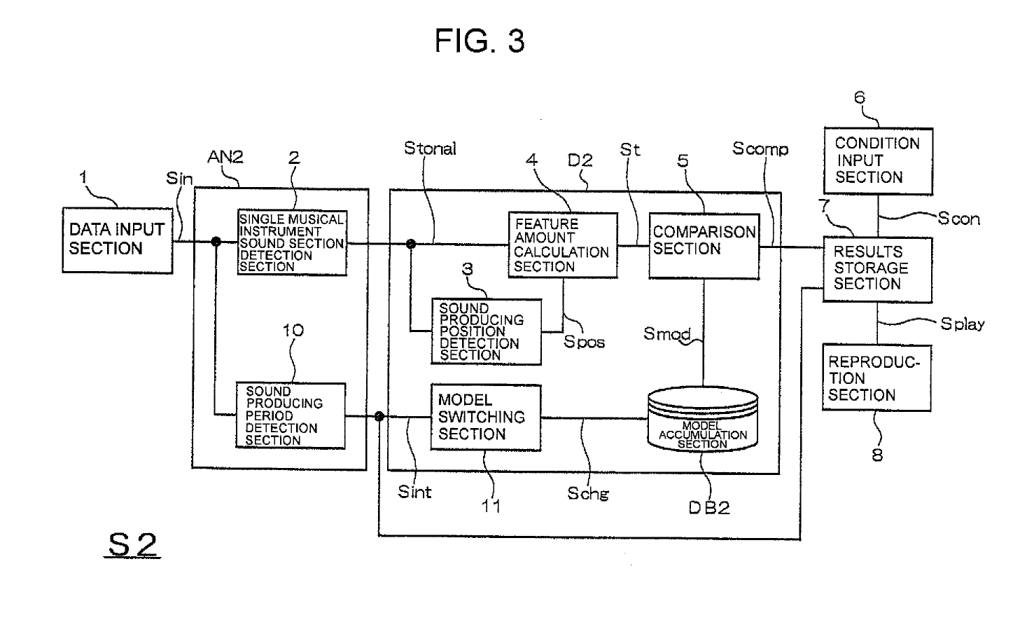

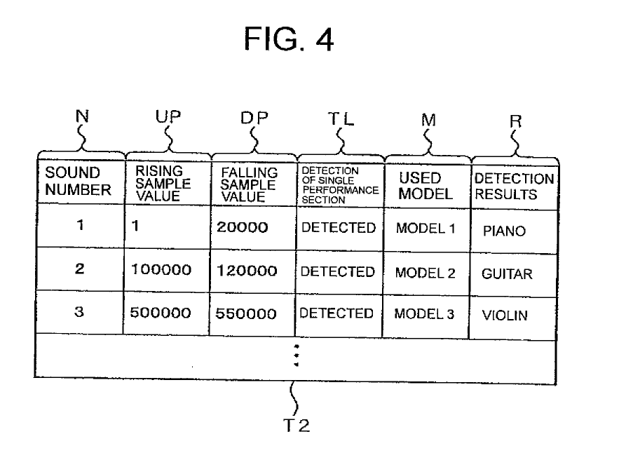

Now, the other, i.e. the second embodiment of the present invention will be described with reference to FIGS. 3 and 4. FIG. 3 is a block diagram showing a schematic structure of a musical composition reproduction apparatus according to the second embodiment of the present invention and FIG. 4 is a view illustrating contents of a detection result table according to the second embodiment of the present invention. In FIGS. 3 and 4, the same reference numerals as the structural components according to the first embodiment of the present invention as shown in FIGS. 1 and 2 are given to the same structural components, and the detailed description of them are omitted.

In the first embodiment as described above of the present invention, the detection of the musical instrument is conducted utilizing the single musical instrument sound data Stonal, which is extracted from the musical composition data Sin by the single musical instrument sound section detection section 2. However, in the second embodiment of the present invention, in addition to the above-described feature, a period of time (a sound producing period) for the respective sounds (each single sound) in the musical composition data Sin is detected, and such detection results are utilized to optimize the musical instrument sound model to be compared in the comparison section 5.

More specifically, as shown in FIG. 3, the musical composition reproduction apparatus S2 according to the second embodiment of the present invention includes a data input section 1, a musical composition analysis section AN2, a musical instrument detection section D2, a condition input section 6, a result storage section 7 and a reproduction section 8. The musical composition analysis section AN2 includes a single musical instrument sound section detection section 2 and a sound producing period detection section 10. In addition, the musical instrument detection section D2 includes a sound producing position detection section 3, a feature amount calculation section 4, a comparison section 5, a model switching section 11 and a model accumulation section DB2.

Now, description will be given below of operation of the musical composition analysis section AN2 and the musical instrument detection section D2, which are specifically provided in the second embodiment of the present invention.

The single musical instrument sound section detection section 2 serving as the musical composition analysis section AN2 generates the single musical instrument sound data Stonal and outputs the same to the musical instrument detection section D2, in the same manner as the first embodiment of the present invention.

In addition, the sound producing period detection section 10 serving as the musical composition analysis section AN2 detects the sound producing period in the musical composition data Sin, generates a period signal Sint indicative of the sound producing period as detected, and then outputs the same to the musical instrument detection section D2 and the result storage section 7.

Then, the musical instrument detection section D2 detects, based on the single musical instrument sound data Stonal and the period signal Sint as inputted from the musical composition analysis section AN2, a musical instrument on which the musical composition in the temporal section corresponding to the single musical instrument sound data Stonal is performed, and generates the detection result signal Scomp, which is indicative of the detection results, and then outputs the same to a results storage section 7.

A model accumulation section DB2 in the musical instrument detection section D2 accumulates a musical instrument sound model for the respective sound producing periods as detected by the sound producing period detection section 10. More specifically, for each kinds of musical instruments, there are accumulated for example a musical instrument sound model, which has been obtained through a leaning utilizing the musical composition data Sin having the sound producing period of 0.5 second in the same manner as the conventional way, a musical instrument sound model, which has been obtained through a leaning utilizing the musical composition data Sin having the sound producing period of 1.0 second in the same manner as the conventional way, and a musical instrument sound model, which has been obtained through a leaning utilizing the musical composition data Sin without limitation of period in the same manner as the conventional way. The respective musical instrument sound models are accumulated so as to be searchable based on the length of the musical composition data Sin utilized in the learning.

The model switching section 11 in the musical instrument detection section D2 generates a control signal Schg to control the model accumulation section DB2 to search the musical instrument sound model, which has been subjected to the learning utilizing the musical composition data Sin, which does not exceed the soundproducing period indicated by the above-mentioned period signal Sint inputted from themusical instrument detection section D2 and has the closest period of time to the above-mentioned sound producing period, to output the same in the form of the above-mentioned model signal Smod, and then outputs the control signal to the model accumulation section DB2.

The comparison section 5 compares the amount of acoustic feature of each of the single sounds indicated by the feature amount signal St with the acoustic model for the respective musical instruments outputted from the model accumulation section DB2 as the model signal Smod, and then generates the above-mentioned detection result signal Scomp.

Then, the results storage section 7, the condition input section 6 and the reproduction section 8 are operated in the same manner as the musical composition reproduction apparatus S1 according to the first embodiment of the present invention, and the contents of the reproduction information Splay is displayed on the not-shown display. When the user selects the musical composition to be reproduced, the reproduction section 8 acquires the musical composition data Sin corresponding to the musical composition as selected, through the not shown network, and then reproduces and outputs the same.

Now, a more specific description of operation of the above-described sound producing period detection section 10 will be given below.

The sound producing period detection section 10 according to the second embodiment of the present invention detects the sound producing period in the musical composition data Sin, and then output the same in the form of the period signal Sint to the musical instrument detection section D2 in a manner as described above. This is based on the expectation that comparison with the musical instrument sound model having the closest period of time as possible to the period of time during which the single sound is produced in the musical composition data Sin would reduce mismatching of the musical instrument sound model with the single musical instrument sound data Stonal.

As the specific sound producing period detection processing, there may be applied any one of a processing in which a peak period of time of the musical composition data Sin, which has been passed through for example a low-pass filter having a cutoff frequency of 1 kHz, is used as the sound producing period, a processing in which a so called autocorrelation period of time in the musical composition data Sin is used as the sound producing period, and a processing in which a period of time from a certain sound producing start timing to the next sound producing start timing, utilizing the results from the above-mentioned sound producing position detection section 3 is used as the sound producing period. In this case, in addition to outputting the sound producing period for each of the single sounds as the period signal Sint, an average value of the sound producing periods in a predetermined period of time may be outputted as the period signal Sint.

Now, description will be given below with reference to FIG. 4 of the contents stored in the results storage section 7, as the results of the musical instrument detection processing in the musical composition reproduction apparatus S2 according to the second embodiment of the present invention.

The above-mentioned detection result signal Scomp, which has been obtained through the above-described operation of the musical composition analysis section AN2 according to the second embodiment of the present invention and the above-described operation of the musical instrument detection section D2, includes, as exemplified in FIG. 4, a used-model information indicative of the musical instrument sound model as actually used in the comparison processing in the comparison section 5, in addition to a sound number information, a rising sample value information, a falling sample value information, a single performance section detection information and a detection result information, which are similar to those of the detection result table T1 according to the first embodiment of the present invention. This used-model information is described, in the detection result table T2, as indicating the musical instrument sound model, which has been subjected to the learning utilizing the musical composition data Sin, which does not exceed the sound producing period indicated by the above-mentioned period signal Sint and has the closest period of time to the above-mentioned sound producing period, based on not shown catalog data that show tabulated contents of the period signal Sint outputted from the above-mentioned sound producing period detection section 10 and the respective musical instrument sound models as accumulated in the above-mentioned model accumulation section DB2.

The results storage section 7 stores the respective information as described above in the form of the detection result table T2 as exemplified in FIG. 4. Here, the above-mentioned detection result table T2 includes a column “M” of the used-model in which the above-mentioned used-model information is described, in addition to the column “N” of the sound number, the column “UP” of the rising sample value, the column “DP” of the falling sample value, the column “TL” of the single performance section detection and the column “R” of the detection results, which are similar to those in the detection result table T1 according to the first embodiment of the present invention.

When the condition information Scon having the contents of for example “Single performance section detection: To be detected; Musical instrument: piano” is inputted to the results storage section 7, in which the detection result table T2 has been stored, the search is conducted in the detection result table T2 on the basis of the inputted conditions, and the information that includes the name of the musical composition, the name of the performer and the like, corresponding to the musical composition data Sin including the single musical instrument sound data Stonal of the sound number “1” (see FIG. 4) is outputted as the above-mentioned reproduction information Splay to the reproduction section 8, in the same manner as the first embodiment of the present invention.

In the above-described operation of the musical component reproduction apparatus S2 according to the second embodiment of the present invention, the musical instrument detection is conducted utilizing the sound producing period in the musical composition data Sin, with the result that the musical composition data Sin corresponding to the respective single sound is used as an object to be detected, and the musical instrument sound model to be compared is optimized, thus permitting an accurate detection of the kind of the musical instrument for the respective sound, in addition to the same technical results provided by the operation of the musical composition reproduction apparatus S1 according to the first embodiment of the present invention.

The inventors of the present invention made specific experiments about high accuracy of the musical instrument detection processing according to the second embodiment of the present invention, and then obtained experimental results, that the detection rate of the music instrument detection processing, in which the musical instrument sound model, which had been subjected to the learning utilizing the musical composition data Sin having the sound producing period of 0.5 second, was applied to the musical composition data Sin having the sound producing period of 0.6 second, was 65% in the number of sound production of 17, the detection rate of the music instrument detection processing, in which the musical instrument sound model, which had been subjected to the learning utilizing the musical composition data Sin having the sound producing period of 0.7 second, was 41% in the number of sound production of 17, and the detection rate of the music instrument detection processing, in which the musical instrument sound model, which had been subjected to the learning utilizing the musical composition data Sin having no limitation of the sound producing period, was 6% in the number of sound production of 17. These results revealed that the operation of the musical component reproduction apparatus 52 according to the second embodiment of the present invention provided excellent technical effects in high detection rate.

### (III) Third Embodiment

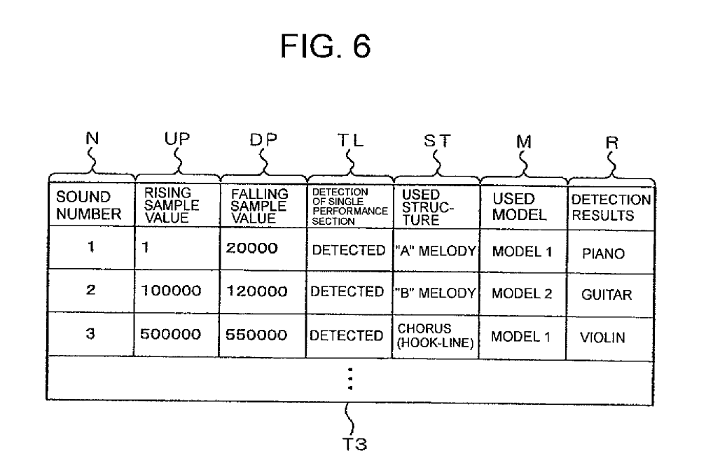

Now, the other, i.e., the third embodiment of the present invention will be described with reference to FIGS. 5 and 6. FIG. 5 is a block diagram showing a schematic structure of a musical composition reproduction apparatus according to the third embodiment of the present invention and FIG. 6 is a view illustrating contents of a detection result table according to the third embodiment of the present invention. In FIGS. 5 and 6, the same reference numerals as the structural components according to the first embodiment of the present invention as shown in FIGS. 1 and 2 and the structural components according to the second embodiment of the present invention as shown in FIGS. 3 and 4 are given to the same structural components, and the detailed description of them are omitted.

The second embodiment as described above of the present invention has a configuration in which the sound producing period in the musical composition data Sin is detected and then the detection results are utilized to optimize the musical instrument sound model to be compared in the comparison section 5, in addition to the configuration of the musical composition reproduction apparatus S1 according to the first embodiment of the present invention. In the third embodiment of the present invention, a structure of the musical composition corresponding to the musical composition data Sin, and more specifically, a musical structure along the temporal axis of the musical composition, such as an introduction part, a chorus (hook-line) part, an “A” melody part, a “B” melody part, etc. is detected, and the detection results are reflected in the musical instrument detection processing, in addition to these configurations according to the first and second embodiments of the present invention.

More specifically, as shown in FIG. 5, the musical composition reproduction apparatus S3 according to the third embodiment of the present invention includes a data input section 1, a musical composition analysis section AN3, a musical instrument detection section D2, a condition input section 6, a result storage section 7, a reproduction section 8 and switches 13, 14. The musical composition analysis section AN3 includes a single musical instrument sound section detection section 2, a sound producing period detection section 10 and a musical composition structure analysis section 12. The configuration and the operation of the musical instrument detection section D2 itself are the same as those of the musical instrument detection section D2 according to the second embodiment of the present invention, and the detailed description of them are therefore omitted.

Now, description will be given below of operation of the musical composition analysis section AN3 and the switches 13, 14, which are specifically provided in the third embodiment of the present invention.

The single musical instrument sound section detection section 2 serving as the musical composition analysis section AN2 generates the single musical instrument sound data Stonal and outputs the same to the musical instrument detection section D2, in the same manner as the first embodiment of the present invention.

The sound producing period detection section 10 generates a period signal Sint and then outputs the same to the musical instrument detection section D2 in the same manner as the first embodiment of the present invention.

In addition to these features, the musical composition structure analysis section 12, which constitutes the musical composition analysis section AN2, the above-mentioned musical structure in the musical composition corresponding to the musical composition data Sin, generates a structure signal San indicative of the musical structure as detected and outputs the same to the result storage section 7, to make an ON/OFF control of the switches 13, 14.

Now, a more specific description of operation of the above-described musical composition structure analysis section 12 will be given below.

The musical composition structure analysis section 12 according to the third embodiment of the present invention detects the musical structure in the musical composition data Sin, e.g., an “A” melody part, a “B” melody part, a chorus (hook-line) part, an interlude part and an ending part, or repetition of these parts, generates the structure signal San indicative of the structure as detected, and outputs the same to the above-mentioned switches 13 and 14, and the result storage section 7. The switches 13 and 14 are turned “ON” or “OFF” based on the above-mentioned structure signal San to control the operation of the musical instrument detection section D2.

More specifically, the switches 13 and 14 are for example turned “OFF” before the second repetition of the musical structure, thus making it possible to reduce the number of processing in the musical instrument detection section D2. To the contrary, the switches 13 and 14 may continuously be turned “ON” in the detection of the repeated part to continuously carry out the analysis processing of the musical structure and the musical instrument detection operation. In this case, the analysis results of the musical structure and the detection results of the musical instrument are preferably accumulated in the result storage section 7. Such a configuration realizes a reproduction mode in which the search conditions of for example “reproduction of the chorus (hook-line) part with the sound of the specified musical instrument” causes the section of the musical composition, wherein the specified structure part of the musical composition (i.e., the “chorus (hook-line)” part in this example) is performed on the specified musical equipment, to be continuously reproduced.

The musical instrument detection section D2 detects, during a period of time in which the switches 13 and 14 are turned “ON”, the musical instrument on which the temporal section of the musical composition corresponding to the single musical instrument sound data Stonal is performed, generates the above-mentioned detection result signal Scomp indicative of the results as detected, and then outputs the same to the results storage section 7, in the same manner as the musical instrument detection section D2 according to the second embodiment of the present invention.

Then, the results storage section 7, the condition input section 6 and the reproduction section 8 are operated in the same manner as the musical composition reproduction apparatus S1 according to the first embodiment of the present invention, and the contents of the reproduction information Splay is displayed on the not-shown display. When the user selects the musical composition to be reproduced, the reproduction section 8 acquires the musical composition data Sin corresponding to the musical composition as selected, through the not shown network, and then reproduces and outputs the same.

As the analysis method of the musical structure in the musical composition structure analysis section 12 according to the third embodiment of the present invention, there is suitably used for example the analysis method described in paragraphs 0014 to 0056 of Japanese Patent Provisional Publication No. 2004-184769 of a patent application filed by the applicant of the present application, and shown in FIGS. 2 to 22 thereof.

Now, description will be given below with reference to FIG. 6 of the contents stored in the results storage section 7, as the results of the musical instrument detection processing in the musical composition reproduction apparatus S3 according to the third embodiment of the present invention.

The above-mentioned detection result signal Scomp, which has been obtained through the above-described operation of the musical composition analysis section AN3 according to the third embodiment of the present invention and the above-described operation of the musical instrument detection section D2, includes, as exemplified in FIG. 6, a used-structure information indicative of what structure part of the musical composition data Sin of the original musical composition is used as the musical composition data Sin (i.e., the single musical instrument sound data Stonal) for detection of the musical instrument, in addition to a sound number information, a rising sample value information, a falling sample value information, a single performance section detection information, a detection result information and the used-model information, which are similar to those of the detection result table T2 according to the second embodiment of the present invention. This used-structure information is described, in the detection result table T3, as the musical structure indicated by the structure signal San outputted from the above-mentioned musical composition structure analysis section 12.

The results storage section 7 stores the respective information as described above in the form of the detection result table T3 as exemplified in FIG. 6. Here, the above-mentioned detection result table T3 includes a column “ST” of the used-structure in which the above-mentioned used-structure information is described, in addition to the column “N” of the sound number, the column “UP” of the rising sample value, the column “DP” of the falling sample value, the column “TL” of the single performance section detection, the column “R” of the detection results and the column “M” of the used-model, which are similar to those in the detection result table T2 according to the second embodiment of the present invention.

When the condition information Scan having the contents of for example “Single performance section detection: To be detected; Musical structure: Chorus (hook-line) part; Musical instrument: piano” (more specifically, the musical composition, which is detected through the single performance section detection and includes the chorus (hook-line) part performed on the piano) is inputted to the results storage section 7, in which the detection result table T3 has been stored, the search is conducted in the detection result table T3 on the basis of the inputted conditions, and the information that includes the name of the musical composition, the name of the performer and the like, corresponding to the musical composition data Sin including the single musical instrument sound data Stonal of the sound number “1” (see FIG. 6) is outputted as the above-mentioned reproduction information Splay to the reproduction section 8.

In the above-described operation of the musical component reproduction apparatus 53 according to the third embodiment of the present invention, the musical instrument detection is conducted utilizing the structure information San indicating for example the introduction part, the chorus (hook-line) part, etc., and the musical structure of the musical composition is utilized to detect the kind of the musical instrument, thus permitting detection of the kind of the musical instrument for the respective musical structure, in addition to the same technical results provided by the operation of the musical composition reproduction apparatus S2 according to the second embodiment of the present invention.

The third embodiment of the present invention is described above as adding the musical composition structure analysis section and the switches 13 and 14 to the musical composition reproduction apparatus S2 according to the second embodiment of the present invention. However, the musical composition structure analysis section 12 and the switch 13 may be added to the musical composition reproduction apparatus S1 according to the first embodiment of the present invention so as to operate in the same manner as the musical composition structure analysis section 12 and the switch 13.

### (IV) Fourth Embodiment

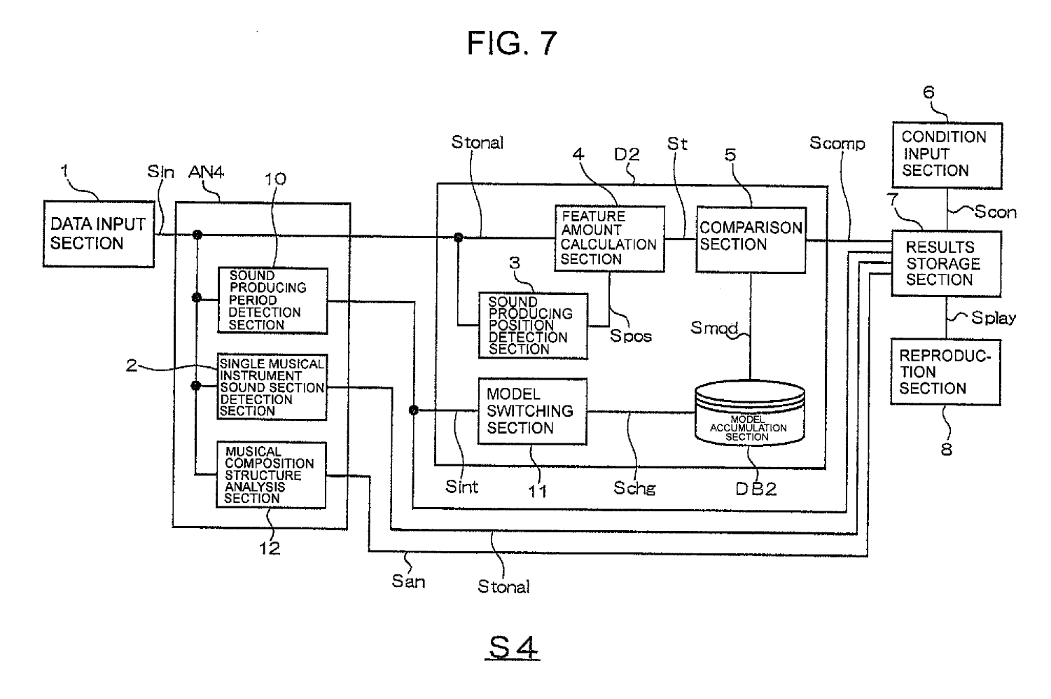

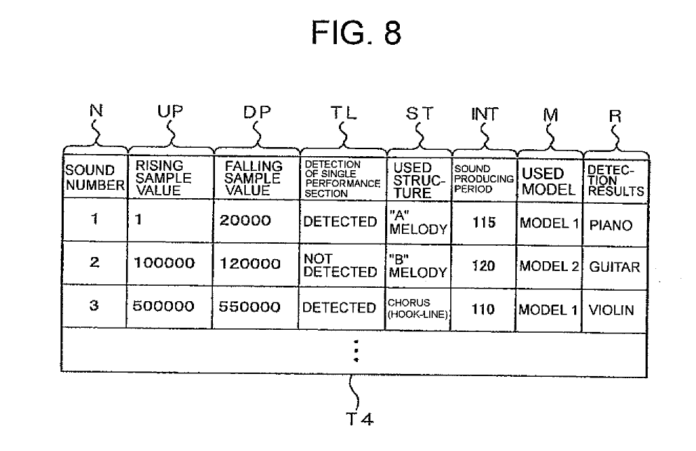

Finally, the other, i.e., the fourth embodiment of the present invention will be described with reference to FIGS. 7 and 8. FIG. 7 is a block diagram showing a schematic structure of a musical composition reproduction apparatus according to the fourth embodiment of the present invention and FIG. 8 is a view illustrating contents of a detection result table according to the fourth embodiment of the present invention. In FIGS. 7 and 8, the same reference numerals as the structural components according to the first embodiment of the present invention as shown in FIGS. 1 and 2, the structural components according to the second embodiment of the present invention as shown in FIGS. 3 and 4 and the structural components according to the third embodiment of the present invention as shown in FIGS. 5 and 6 are given to the same structural components, and the detailed description of them are omitted.

In the first to third embodiments as described above of the present invention, the processing according to the first embodiment of the present invention of detecting the single musical instrument sound section, the processing according to the second embodiment of the present invention of detecting the sound producing period, and the processing according to the third embodiment of the present invention of analyzing the structure of the musical composition are carried out as a pre-step for the musical instrument detection processing in the musical instrument detection section D1 or D2. However, in the fourth embodiment of the present invention described below, only the sound producing period detection processing according to the second embodiment of the present invention is carried out as the pre-step for the musical instrument detection processing. In addition, the above-described detection result signal Scomp obtained as the results of the musical instrument detection processing is subjected to the search refinement based on the results of the single musical instrument sound section detection processing and the results of the musical composition structure analysis processing.

More specifically, as shown in FIG. 7, the musical composition reproduction apparatus S4 according to the fourth embodiment of the present invention includes a data input section 1, a musical composition analysis section AN4, a musical instrument detection section D2 serving as the first detection unit, a condition input section 6, a result storage section 7 serving as a kind judgment unit, and a reproduction section 8. The musical composition analysis section AN4 includes a sound producing period detection section 10, a single musical instrument sound section detection section 2 serving as the second detection unit, and a musical composition structure analysis section 12.

Now, operation will be described below.

First, the data input section 1 outputs the musical composition data Sin serving as an object to be subject to the musical instrument detection to the sound producing period detection section 10 of the musical composition analysis section AN4, and outputs directly to the musical instrument detection section D2.

The sound producing period detection section 10 generates the above-mentioned period signal Sint in the same manner as the sound producing period detection section 10 according to the second embodiment of the present invention, and outputs the same to the model switching section 11 of the musical instrument detection section D2, and to the result storage section 7.

On the other hand, the musical instrument detection section D2 conducts the same operation as the musical instrument detection section D2 according to the second embodiment of the present invention, for the whole musical composition data Sin as directly inputted, generates the detection result signals Scamp as the musical instrument detection results for the whole musical composition data Sin, and then outputs the same to the result storage section 7.

The single musical instrument sound section detection section 2 according to the fourth embodiment of the present invention generates the above-mentioned single musical instrument sound data Stonal in the same manner as the operation of the single musical instrument sound section detection section 2 according to the first embodiment of the present invention, and then directly outputs the same to the result storage section 7. In addition, the musical composition structure analysis section 12 according to the fourth embodiment of the present invention generates the above-mentioned structure signal San in the same manner as the operation of the musical composition structure analysis section 12 according to the third embodiment of the present invention, and then directly outputs the same to the result storage section 7.

The results storage section 7 stores the above-mentioned single musical instrument sound data Stonal, the above-mentioned period signal Sint, the above-mentioned structure signal San, and the above-mentioned detection result signal Scomp for the whole musical composition data Sin, in the form of the detection result table T4.

Now, the contents of the detection result table T4 will be described with reference to FIG. 8.

The contents of the detection result table T4 stored in the result storage section 7 according to the fourth embodiment of the present invention includes, as exemplified in FIG. 8, a sound producing period information indicative of the sound producing period inputted as the above-mentioned period signal Sint, in addition to a sound number information, a rising sample value information, a falling sample value information, a single performance section detection information, a detection result information, a used-model information and a used-structure information, which are similar to those of the detection result table T3 according to the third embodiment of the present invention.

The detection result table T4 includes a column “INT” of the sound producing period in which the above-mentioned sound producing period is described, in addition to the column “N” of the sound number, the column “UP” of the rising sample value, the column “DP” of the falling sample value, the column “TL” of the single performance section detection, the column “R” of the detection results, the column “M” of the used-model and the column “ST” of the used structure, which are similar to those in the detection result table T2 according to the third embodiment of the present invention. Of these columns, the describing operation in the column “TL” of the single performance section detection is made based on the contents of the single musical instrument sound data Stonal outputted from the sound producing period detection section 10 according to the fourth embodiment of the present invention, unlike the first to third embodiments of the present invention.

When the condition information Scon having the contents of for example “Single performance section detection: To be detected; Musical structure: Chorus (hook-line) part; Musical instrument: piano” is inputted to the results storage section 7, in which the detection result table T4 has been stored, the results storage section 7 selects, while referring to the contents of the above-mentioned detection result table T4, only the musical instrument detection results that were obtained utilizing an object to be detected of the musical instrument data Sin, which corresponded to the single musical instrument sound data Stonal and to the chorus (hook-line) part, from the results of the musical instrument detection processing, which was carried out for the whole musical composition data Sin by the musical instrument detection section D2, and then outputs the same to the reproduction section 8 in the form of the reproduction information Splay. As a result, the reproduction section 8 acquires the information that includes the name of the musical composition, the name of the performer and the like, corresponding to the musical composition data Sin including the single musical instrument sound data Stonal of the sound number “1” (see FIG. 8).

When the user selects the musical composition to be reproduced, the reproduction section 8 acquires the musical composition data Sin corresponding to the musical composition as selected, through the not shown network, and then reproduces and outputs the same.

In the above-described operation of the musical component reproduction apparatus S4 according to the fourth embodiment of the present invention, only the sound producing period detection processing according to the second embodiment of the present invention is carried out as the pre-step for the musical instrument detection processing, and the above-described detection result signal Scamp obtained as the results of the musical instrument detection processing is subjected to the search refinement based on the results of the single musical instrument sound section detection processing and the results of the musical composition structure analysis processing. When the user wishes to cause the whole musical composition data Sin to be previously subjected to the single musical instrument sound section detection processing and the musical composition structure analysis processing, irrespective of the single musical instrument sound section, and then, change the setting of these processing to obtain the processing results, it is possible to obtain the appropriate analysis results for the desired matters, without carrying out all the processing again.

In addition, the musical composition data Sin corresponding to the respective single sounds is subjected to the detection for the kind of the musical instrument to optimize the musical instrument sound model to be compared, thus making it possible to detect the kind of the musical instrument for the respective sounds in an accurate manner.

In addition, detection of the kind of themusical instrument is made utilizing the musical structure of the musical composition, such as an introduction part, a chorus (hook-line) part, etc. Judgment based on this musical structure permits improvement of the detection accuracy of the kind of the musical instrument.

Further, it is possible to utilize a general-purpose computer as any one of the musical composition analysis sections AN1 to AN4 or any one of the musical instrument detection sections D1 and D2 according to the embodiments of the present invention, by recording a program corresponding to the operation of any one of the musical composition analysis sections AN1 to AN4 or any one of the musical instrument detection sections D1 and D2 in an information recording medium such as a flexible disc, a hard disc or the like, or acquiring the program through the internet to record in it, and reading out the program by the computer to execute the program.

1-12. (canceled)

13. A musical composition data analysis apparatus, which analyzes musical composition data corresponding to a musical composition and generates a kind detection signal for detecting a kind of musical instrument on which the musical composition is performed, said apparatus comprises:
a detection unit that detects a musical feature along a temporal axis of the musical composition data; and
a generation unit that generates the kind detection signal based on the musical feature as detected,
wherein:
said musical feature comprises a temporal structure in the musical composition; and
said generation unit generates, as said kind detection signal, information which is indicative of said temporal structure in the musical composition data.

14. The musical composition data analysis apparatus as claimed in claim 13, wherein:
said musical feature comprises a single musical sound section in a temporal section of the musical composition data, which is judged acoustically as being composed of any one of a sound of a single musical instrument and a singing sound of a single singer; and
said generation unit generates, as said kind detection signal, information which is indicative of said single musical sound section in the musical composition data.

15. The musical composition data analysis apparatus as claimed in claim 13, wherein:
said musical feature comprises a sound producing period of time during which a sound corresponding to a single musical note in the musical composition data is produced; and
said generation unit generates, as said kind detection signal, information which is indicative of said sound producing period of time in the musical composition data.

16. A musical instrument kind detection apparatus comprises:
(i) a musical composition data analysis apparatus, which analyzes musical composition data corresponding to a musical composition and generates a kind detection signal for detecting a kind of musical instrument on which the musical composition is performed, said apparatus comprises:
a detection unit that detects a musical feature along a temporal axis of the musical composition data; and
a generation unit that generates the kind detection signal based on the musical feature as detected,
wherein:
said musical feature comprises a temporal structure in the musical composition; and
said generation unit generates, as said kind detection signal, information which is indicative of said temporal structure in the musical composition data; and
(ii) a kind detection unit that utilizes the musical composition data corresponding to the musical feature indicated by the kind detection signal as generated to detect said kind.

17. A musical composition data analysis method, which analyzes musical composition data corresponding to a musical composition and generates a kind detection signal for detecting a kind of musical instrument on which the musical composition is performed, said method comprises:
a detection step for detecting a musical feature along a temporal axis of the musical composition data; and
a generation step for generating the kind detection signal based on the musical feature as detected,
wherein:
said musical feature comprises a temporal structure in the musical composition; and
said generation step generates, as said kind detection signal, information which is indicative of said temporal structure in the musical composition data.

18. A non-transitory computer readable recording medium in which a musical composition data analysis program is recorded, which is to be executed by a computer to which musical composition data corresponding to a musical composition are inputted, to cause the computer to function as a musical composition data analysis apparatus, which analyzes musical composition data corresponding to a musical composition and generates a kind detection signal for detecting a kind of musical instrument on which the musical composition is performed, said apparatus comprises:
a detection unit that detects a musical feature along a temporal axis of the musical composition data; and
a generation unit that generates the kind detection signal based on the musical feature as detected,
wherein:
said musical feature comprises a temporal structure in the musical composition; and
said generation unit generates, as said kind detection signal, information which is indicative of said temporal structure in the musical composition data.

19. A non-transitory computer readable recording medium in which a musical instrument kind detection program is recorded, which is to be executed by a computer to which musical composition data corresponding to a musical composition are inputted, to cause the computer to function as a musical instrument kind detection apparatus comprises:
(i) a musical composition data analysis apparatus, which analyzes musical composition data corresponding to a musical composition and generates a kind detection signal for detecting a kind of musical instrument on which the musical composition is performed, said apparatus comprises:
a detection unit that detects a musical feature along a temporal axis of the musical composition data; and
a generation unit that generates the kind detection signal based on the musical feature as detected,
wherein:
said musical feature comprises a temporal structure in the musical composition; and
said generation unit generates, as said kind detection signal, information which is indicative of said temporal structure in the musical composition data; and
(ii) a kind detection unit that utilizes the musical composition data corresponding to the musical feature indicated by the kind detection signal as generated to detect said kind.

20. The musical composition data analysis apparatus as claimed in claim 14, wherein:
said musical feature comprises a sound producing period of time during which a sound corresponding to a single musical note in the musical composition data is produced; and
said generation unit generates, as said kind detection signal, information which is indicative of said sound producing period of time in the musical composition data.
